(19) United States
(12) Patent Application Publication
(10) Pub. No.: US 2020/0027153 A1
(43) Pub. Date: Jan. 23, 2020

(54) INFORMATION PROCESSING DEVICE, TERMINAL APPARATUS, INFORMATION PROCESSING SYSTEM, RECORDING MEDIUM, AND CONTROL METHOD

(71) Applicant: SHARP KABUSHIKI KAISHA, Sakai City (JP)

(72) Inventors: TAKASHI OHTA, Sakai City (JP); HIROYUKI NAKAMURA, Sakai City (JP); TAMON MOTOYA, Sakai City (JP); AKIHIRO AZUMA, Sakai City (JP)

(21) Appl. No.: 16/450,062

(22) Filed: Jun. 24, 2019

(30) Foreign Application Priority Data
Jul. 19, 2018 (JP) 2018-136199

(51) Int. Cl. G06Q 30/06; G06Q 10/08

(52) U.S. Cl. CPC G06Q 30/0635; G06Q 10/083

(57) ABSTRACT

After acquiring order information on an order from a user, a food ingredients delivery instruction corresponding to the order information is transmitted due to acquiring of trigger information including at least one of user identification information, device identification information, and order identification information.

### BACKGROUND

### 1. Field

The present disclosure relates to an information processing device, a terminal apparatus, an information processing system, a recording medium, and a control method.

### 2. Description of the Related Art

In a related art, there is a distribution system in which a user orders a plurality of goods using a computer network and simultaneously receives a plurality of ordered goods. In these distribution systems, a plurality of goods received from a plurality of companies are collectively delivered to users. For example, the distribution system can receive goods from each of a company supplying food ingredients and a company supplying cooking appliances, and collectively deliver the food ingredients and the cooking appliances to the user (for example, PTL 1).

Meanwhile, in recent years, a cooking appliance is available, which downloads a recipe through networks such as the Internet. This cooking appliance has a problem that installation may take time such that when food ingredients and the cooking appliance are delivered collectively, there is a risk that the installation of the cooking appliance does not finish before the expiration date of the food ingredients and the user is not able to properly cook the food ingredients.

One aspect of the present disclosure has been made in view of the above circumstances, and it is desirable to provide a technique for enabling a delivery of food ingredients so that the food ingredients can be properly cooked.

### SUMMARY

In order to solve the above problem, according to an aspect of the present disclosure, there is provided an information processing device including a communication unit and a control unit, in which the control unit, after acquiring order information on an order from a user through the communication unit, transmits a food ingredients delivery instruction corresponding to the order information, due to acquiring of trigger information including at least one of user identification information, device identification information, and order identification information.

In order to solve the above problem, according to another aspect of the present disclosure, there is provided a terminal apparatus which communicates with the information processing device, in which, after acquiring the order information, the information processing device transmits the food ingredients delivery instruction corresponding to the order information due to acquiring of the trigger information including at least one of the user identification information, the device identification information, and the order identification information, and the terminal apparatus transmits the trigger information to the information processing device.

In order to solve the above problem, according to still another aspect of the present disclosure, there is provided an information processing system including: an order information transmission unit which transmits order information; a trigger information transmission unit which transmits trigger information including at least one of user identification information, device identification information, and order identification information; and a control unit which, after acquiring the order information, causes a food ingredients delivery instruction transmission unit to transmit a food ingredients delivery instruction corresponding to the order information due to acquiring of the trigger information.

In order to solve the above problem, according to still another aspect of the present disclosure, there is provided a control method of an information processing device including a communication unit and a control unit, the method including: acquiring order information on an order from a user through the communication unit; acquiring trigger information including at least one of user identification information, device identification information, and order identification information; and transmitting a food ingredients delivery instruction corresponding to the order information due to acquiring of the trigger information.

### BRIEF DESCRIPTION OF THE DRAWINGS

FIG. 1 is a block diagram showing a main composition of an information processing system according to Embodiment 1;

FIG. 2 is a block diagram schematically showing a schematic composition of the information processing system according to Embodiment 1;

FIG. 3A is a diagram showing a data table including user information stored in a unit of a user management server, and FIG. 3B is a diagram showing a data table including order information stored in a storage unit of an order management server;

FIG. 4 is a diagram showing a data table including device registration information;

FIG. 5A is a diagram showing a data table including food ingredients information, and FIG. 5B is a diagram showing a data table including food ingredients delivery schedule;

FIG. 6A is a diagram showing a data table including recipe information, and FIG. 6B is a diagram showing a data table including a message;

FIG. 7 is a sequence diagram showing processing by the information processing system;

FIG. 8 is a sequence diagram showing processing by an information processing system according to a modified example; and

FIG. 9 is a block diagram illustrating a composition of a computer that can be used as an information processing device.

### DESCRIPTION OF THE EMBODIMENTS

### Embodiment 1

Hereinafter, Embodiment 1 according to the present disclosure will be described in detail.

### Overview of Information Processing System 110

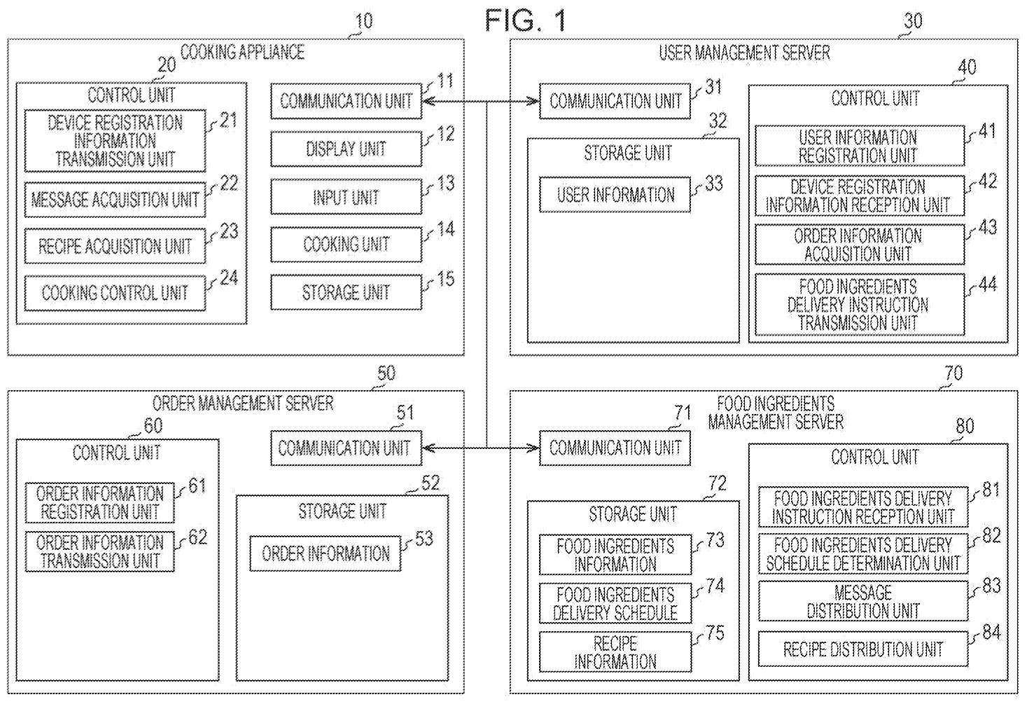

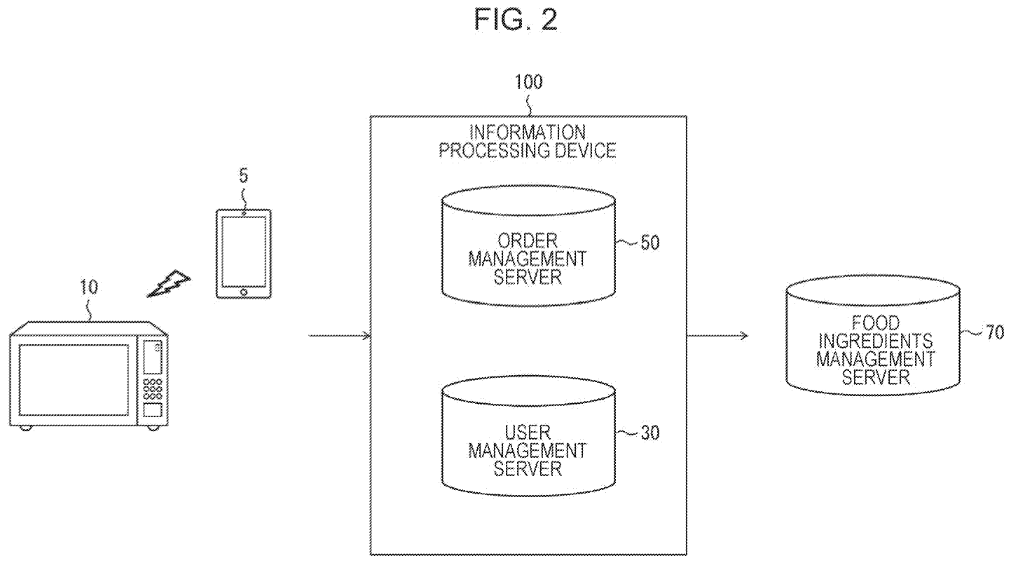

FIG. 1 is a block diagram showing the main composition of an information processing system 110 according to the present embodiment. FIG. 2 is a diagram schematically showing a schematic composition of the information processing system 110.

As shown in FIGS. 1 and 2, the information processing system 110 includes a cooking appliance 10, a user management server 30, an order management server 50, and a food ingredients management server 70. In the information processing system 110, the cooking appliance 10, the user management server 30, the order management server 50, and the food ingredients management server 70 are configured to be able to communicate with each other by communication through a network such as the Internet. In the following description, the user management server 30 and the order management server 50 are collectively referred to as an information processing device 100.

In addition, in the following explanation, although the structure in which the user management server 30, the order management server 50, and the food ingredients management server 70 are respectively configured by an individual server is described, it is not limited thereto. For example, the user management server 30 and the food ingredients management server 70 may be realized by the same server, or the order management server 50 and the food ingredients management server 70 may be realized by the same server.

In the information processing system 110, the information processing device 100 serves as a server on a network to which one or a plurality of cooking appliances 10 are connected.

In addition, a terminal apparatus 5 such as a smartphone may be connectable to the cooking appliance 10. The cooking appliance 10 and the terminal apparatus 5 may be connected by Bluetooth (registered trademark), ANT, and the like, which is a low power consumption short distance wireless communication, for example. Moreover, the cooking appliance 10 and the terminal apparatus 5 may be connected by Wi-Fi (registered trademark) communication, and the like through a router. Further, the cooking appliance 10 may be configured as a terminal apparatus that communicates with the information processing device 100 in the information processing system 110.

The cooking appliance 10 may be configured to be directly connected to the information processing device 100 through a network, or may be configured to be connected to the information processing device 100 through the terminal apparatus 5. In addition, the cooking appliance 10 may receive information from the food ingredients management server 70 by so-called polling, or may receive information using the WebSocket technology or the like.

In the information processing system 110, when the cooking appliance 10 is ordered at the same time as the food ingredients, the user information and the order information are registered in the information processing device 100. For example, when the user orders the cooking appliance 10 and the food ingredients (cooking kit) at the same time from a website such as an EC store, the user information and the order information are input by the user through the website, and is registered respectively in the user management server 30 and the order management server 50. In addition, when the user orders the cooking appliance 10 and the food ingredients at the same time at a store such as a consumer electronics retail store, the user information and the order information may be registered respectively in the user management server 30 and the order management server 50 from a website such as an EC site by a salesperson of the store.

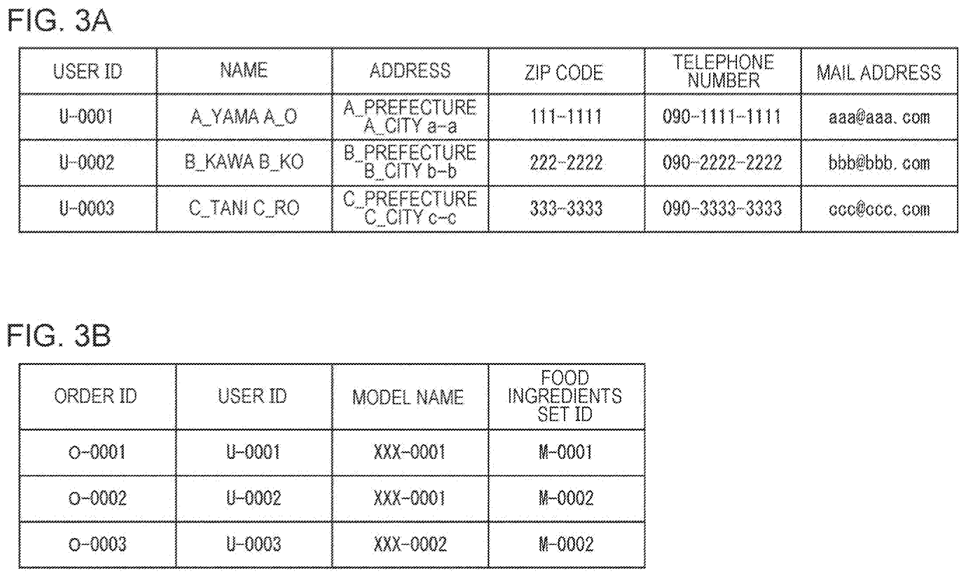

FIG. 3A shows an example of a user information table in which user information is written. In the user information, as shown in FIG. 3A, the user information is information associated with a user ID. The user ID is user identification information for identifying each user, and is information unique to each user. The user information includes information such as name, address, zip code, telephone number, and mail address of the user associated with the user ID.

FIG. 3B shows an example of an order information table in which the order information is written. As shown in FIG. 3B, the order information is information associated with an order ID. The order ID is order identification information for identifying each order, and is information unique to each order. The order information includes information such as a user ID, model name, and a food ingredients set ID associated with the order ID.

When receiving the notification indicating that the initial configuration of the cooking appliance 10 is completed, the information processing device 100 transmits a notification instructing delivery of the food ingredients to the food ingredients management server based on the user information and the order information.

The cooking appliance 10 and the terminal apparatus 5 are not limited to separate composition, and the cooking appliance 10 may have the function of the terminal apparatus 5. Further, the cooking appliance 10 may be configured to have a part of the functions of the information processing device 100.

### Main Composition of Cooking Appliance 10

As shown in FIG. 1, the cooking appliance 10 as a terminal apparatus which communicates with the information processing device 100 includes a communication unit 11, a display unit 12, an input unit 13, a cooking unit 14, a storage unit 15, and a control unit 20. The cooking appliance 10 is an apparatus such as an oven range or an automatic cooker that may complete cooking only by performing an operation to start cooking (for example, pressing a start button) by introducing a food ingredients. The cooking appliance 10 is an apparatus which may be suitably used in a general household.

The cooking appliance 10 may be configured to include one or a plurality of control units, one or a plurality of communication units, and one or a plurality of cooking units, and may be configured such that the control unit, the communication unit, and the cooking unit perform processing in combination with each other.

The communication unit 11 communicates with the user management server 30, the order management server 50, and the food ingredients management server 70 through the Internet and the like, for example. In addition, the communication unit 11 communicates with the terminal apparatus 5 through short distance wireless communication. The communication unit 11 may be configured of a plurality of communication devices including a communication device providing a function of short distance wireless communication and a communication device providing a function of wired or wireless communication.

The communication unit 11 communicates with the user management server 30 and transmits device registration information, which is information on the registration of the cooking appliance 10, to the user management server 30. In addition, the communication unit 11 communicates with the food ingredients management server 70, and receives a message about food ingredients delivery and a recipe for cooking the food ingredients from the food ingredients management server.

Further, the communication unit 11 may communicate with the terminal apparatus 5 such as a smartphone, and may communicate with the user management server 30 and the food ingredients management server 70 through the terminal apparatus 5. In this case, an application for performing communication with the user management server 30 and the food ingredients management server 70 is installed in advance in the terminal apparatus 5, and the terminal apparatus 5 may be configured to exchange information with the user management server 30 and the food ingredients management server 70 by executing the application.

The display unit 12 is a display device such as a liquid crystal display, an organic electro luminescence display (OLED), and a plasma display, for example. The display unit 12 denotes an image on a display screen based on the control of the control unit 20. The display unit 12 denotes information on a schedule of food ingredients delivery, a recipe, and the like received from the food ingredients management server 70 through the communication unit 11.

The input unit 13 includes operation buttons and a touch panel superimposed on the display unit 12, and receives an instruction based on an operation of the user on the operation buttons and the touch panel.

The cooking unit 14 cooks the food ingredients in the cooking unit 14 according to the cooking method such as steaming, baking, frying and boiling, the cooking temperature, and the cooking time based on the control of the control unit 20.

The storage unit 15 is a storage for storing various data used by the control unit 20. The storage unit 15 is realized by any one of EPROM, EEPROM (registered trademark), HDD, flash memory, and the like, which is a non-volatile memory of which contents can be rewritten, or a combination of one or more thereof, for example.

The control unit 20 is an arithmetic device provided with a function to control each unit of the cooking appliance 10 in an integrated manner. The control unit 20 controls each unit of the cooking appliance 10 by executing a program stored in one or more memories (for example, a RAM or a ROM) by one or more processors (for example, a CPU or the like), for example.

### Composition of Control Unit 20

The control unit 20 includes a device registration information transmission unit 21, a message acquisition unit 22, a recipe acquisition unit 23, and a cooking control unit 24.

The device registration information transmission unit 21 transmits device registration information to the user management server 30 through the communication unit 11 as information indicating that a preparation of the cooking appliance 10 is completed. When the preparation of the cooking appliance 10 is completed, it indicates a state including at least one of the state that the installation and initial configuration of the cooking appliance 10 is completed by the user, and the state that the cooking appliance 10 is ready for cooking.

The device registration information is information associated with a device ID. The device ID is device identification information for identifying each of the plurality of cooking appliances 10, and is information unique to each cooking appliance 10. The device ID may be manufacture's serial number of each cooking appliance 10.

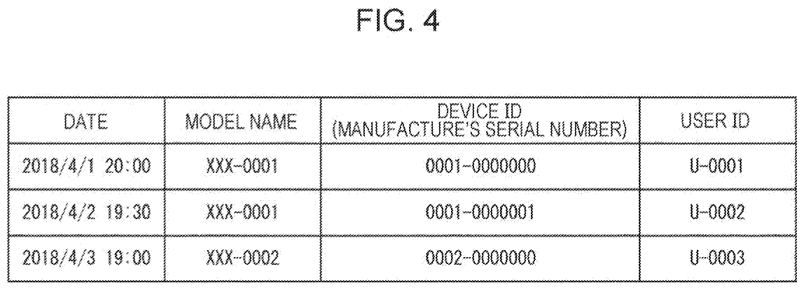

FIG. 4 shows an example of the device registration information table in which the device registration information is written. As shown in FIG. 4, the device registration information includes a date when the device registration information is transmitted, a model name of the cooking appliance 10, a device ID of the cooking appliance 10, and a user ID which is information for identifying the user of the cooking appliance 10.

As described above, the device registration information transmission unit 21 transmits trigger information including at least one of the user ID and the device ID to the user management server 30. The trigger information transmitted by the device registration information transmission unit 21 may include information for identifying an order.

The message acquisition unit 22 acquires a message transmitted from the food ingredients management server 70 through the communication unit 11. The message acquired by the message acquisition unit 22 is a message notifying that the delivery schedule of the food ingredients is determined, or a message notifying the delivery schedule of the food ingredients, for example.

The recipe acquisition unit 23 acquires a recipe transmitted from the food ingredients management server 70 through the communication unit 11. The recipe acquired by the recipe acquisition unit 23 includes a cooking data such as a cooking method, a cooking temperature, and a cooking time for cooking the ordered food ingredients in the cooking unit 14.

The cooking control unit 24 controls the cooking unit 14 to cause the cooking unit 14 to perform cooking, according to the recipe acquired by the recipe acquisition unit 23.

### Main Composition of User Management Server 30

As shown in FIG. 1, the user management server 30 includes a communication unit 31, a storage unit 32, and a control unit 40. It should be noted that, in the present embodiment, the information processing system 110 including one user management server 30 is described as an example, but the present disclosure is not limited thereto. For example, the user management server 30 may be configured of a plurality of servers, or may be configured such that a plurality of servers perform processing for executing the following function in combination with each other.

In addition, in the present embodiment, the user management server 30 including one control unit 40 is described as an example, but the present disclosure is not limited thereto. For example, the user management server 30 may be configured to include one or a plurality of control units, and such that the plurality of control units perform processing in combination with each other. In addition, the user management server 30 may be configured to include one or a plurality of communication units, and such that the plurality of communication units may jointly perform communication with an external server or an external device.

The user management server 30 is a server which manages information on users associated with each of the one or a plurality of cooking appliances 10. The user management server 30 has a function of managing membership registration information of the users and performing login authentication of the users. In addition, the user management server 30 manages information on cooking appliances owned by each user.

The communication unit 31 communicates with one or a plurality of cooking appliances 10, order management servers 50, and food ingredients management servers 70 through a network such as the Internet, for example.

The storage unit 32 is a storage for storing various data used by the control unit 40. The storage unit 32 is realized by any one of EPROM, EEPROM (registered trademark), HDD, flash memory, and the like, which is a non-volatile memory of which contents may be rewritten, or a combination of one or more thereof, for example.

The storage unit 32 stores user information 33. As exemplified in the user information table shown in FIG. 3A, the user information 33 includes information on each of a plurality of users associated with the user ID.

The control unit 40 is an arithmetic device provided with a function to control each unit of the user management server 30 in an integrated manner. The control unit 40 controls each unit of the user management server 30 by executing a program stored in one or more memories (for example, a RAM or a ROM) by one or more processors (for example, a CPU or the like), for example.

### Composition of Control Unit 40

The control unit 40 includes a user information registration unit 41, a device registration information reception unit 42, an order information acquisition unit 43, and a food ingredients delivery instruction transmission unit 44.

The user information registration unit 41 acquires user information input from the EC site through the communication unit 31, and stores the user information in the storage unit 32 together with the user information of other users.

The device registration information reception unit 42 receives the device registration information transmitted from the cooking appliance 10 through the communication unit 31.

The order information acquisition unit 43, triggered by the reception of the device registration information at the device registration information reception unit 42, inquires of the order management server 50 about the order information, and acquires the order information transmitted from the order management server 50 through the communication unit 31. The order information acquisition unit 43 may inquire of the order management server 50 about the order information based on at least one of the user ID and the device ID included in the device registration information.

The food ingredients delivery instruction transmission unit 44 transmits a food ingredients delivery instruction to the food ingredients management server 70 through the communication unit 31 based on the order information acquired by the order information acquisition unit 43. The order information acquisition unit 43 may transmit a food ingredients delivery instruction to the food ingredients management server 70 based on the order ID.

For example, it is assumed that the device registration information reception unit 42 receives the device registration information of the cooking appliance 10 associated with a user ID “U-0001”. The order information acquisition unit 43, triggered by the reception of the device registration information, inquires of the order management server 50 about order information associated with the user ID “U-0001”. The order information acquisition unit 43 acquires order information associated with the user ID “U-0001”.

When the order information acquisition unit 43 acquires the order information associated with the user ID “U-0001”, the food ingredients delivery instruction transmission unit 44 extracts information such as address, name, zip code, telephone number, and mail address of the user associated with the user ID “U-0001” from the user information. The food ingredients delivery instruction transmission unit 44 generates a food ingredients delivery instruction which includes a food ingredients set ID and information such as address, name, zip code, telephone number, and mail address of the user included in the order information. The food ingredients delivery instruction transmission unit 44 transmits the generated food ingredients delivery instruction to the food ingredients management server 70 through the communication unit 31 in association with the delivery ID which is a unique ID for each delivery.

As described above, the control units 40 and 60 of the user management server 30 and the order management server 50 acquire the order information on the order from the user through the communication units 31 and 51 and then, triggered by the reception of the device registration information, transmit the food ingredients delivery instruction corresponding to the order information. That is, the device registration information is used as trigger information serving as a trigger for transmitting the food ingredients delivery instruction corresponding to the order information. The trigger information includes at least one of a user ID, a device ID, and an order ID.

### Main Composition of Order Management Server 50

The order management server 50 includes a communication unit 51, a storage unit 52, and a control unit 60. It should be noted that, in the present embodiment, the information processing system 110 including one order management server 50 is described as an example, but the present disclosure is not limited thereto. For example, the order management server 50 may be configured of a plurality of servers, or may be configured such that a plurality of servers perform processing for executing the following function in combination with each other.

In addition, in the present embodiment, the order management server 50 including one control unit 60 is described as an example, but the present disclosure is not limited thereto. For example, the order management server 50 may be configured to include one or a plurality of control units, and such that the plurality of control units perform processing in combination with each other. In addition, the order management server 50 may be configured to include one or a plurality of communication units, and such that the plurality of communication units may jointly perform communication with an external server or an external device.

The order management server 50 is a server which manages information on orders of food ingredients associated with each of the one or a plurality of cooking appliances 10. The order management server 50 may have a function of managing a history of the order the food ingredients in association with each cooking appliance 10.

The communication unit 51 communicates with the user management server 30 and the food ingredients management server 70 through a network such as the Internet, for example.

The storage unit 52 is a storage for storing various data used by the control unit 60. The storage unit 52 is realized by any one of EPROM, EEPROM (registered trademark), HDD, flash memory, and the like, which is a non-volatile memory of which contents may be rewritten, or a combination of one or more thereof, for example.

The storage unit 52 stores order information 53. The order information 53 includes information on each of a plurality of orders associated with the order ID, as exemplified in the order information table shown in FIG. 3B.

The control unit 60 is an arithmetic device provided with a function to control each unit of the order management server 50 in an integrated manner. The control unit 60 controls each unit of the order management server 50 by executing a program stored in one or more memories (for example, a RAM or a ROM) by one or more processors (for example, a CPU or the like), for example.

### Composition of Control Unit 60

The control unit 60 includes an order information registration unit 61 and an order information transmission unit 62.

The order information registration unit 61 acquires order information input from the EC site through the communication unit 51, and stores the order information in the storage unit 52 together with information on other orders.

The order information transmission unit 62 transmits the order information to the user management server 30 through the communication unit 51 based on the inquiry about the order information received from the user management server 30.

For example, it is assumed that the device registration information reception unit 42 receives the device registration information of the cooking appliance 10 associated with the user ID “U-0001”. The order information acquisition unit 43, triggered by the reception of the device registration information, inquires of the order management server 50 about order information associated with the user ID “U-0001”. The order information acquisition unit 43 acquires order information associated with the user ID “U-0001”.

When the order information acquisition unit 43 acquires the order information associated with the user ID “U-0001”, the food ingredients delivery instruction transmission unit 44 extracts information such as address, name, zip code, telephone number, and mail address of the user associated with the user ID “U-0001” from the user information. The food ingredients delivery instruction transmission unit 44 generates a food ingredients delivery instruction which includes a food ingredients set ID and information such as address, name, zip code, telephone number, and mail address of the user included in the order information. The food ingredients delivery instruction transmission unit 44 transmits the generated food ingredients delivery instruction to the food ingredients management server 70 through the communication unit 31 in association with the delivery ID which is a unique ID for each delivery.

### Main Composition of Food Ingredients Management Server 70

The food ingredients management server 70 includes a communication unit 71, a storage unit 72, and a control unit 80. It should be noted that, in the present embodiment, the information processing system 110 including one food ingredients management server 70 is described as an example, but the present disclosure is not limited thereto. For example, the food ingredients management server 70 may be configured of a plurality of servers, or may be configured such that a plurality of servers perform processing for executing the following function in combination with each other.

In addition, in the present embodiment, the food ingredients management server 70 including one control unit 80 is described as an example, but the present disclosure is not limited thereto. For example, the food ingredients management server 70 may be configured to include one or a plurality of control units, and such that the plurality of control units perform processing in combination with each other. In addition, the food ingredients management server 70 may be configured to include one or a plurality of communication units, and such that the plurality of communication units may jointly perform communication with an external server or an external device.

The food ingredients management server 70 is a server which manages information such as food ingredients to be cooked by the cooking appliance 10, a delivery schedule of the food ingredients, and a recipe that is information on a cooking method of the food ingredients.

The communication unit 71 communicates with the cooking appliance 10, the user management server 30, and the order management server 50 through a network such as the Internet, for example.

The storage unit 72 is a storage for storing various data used by the control unit 80. The storage unit 72 is realized by any one of EPROM, EEPROM (registered trademark), HDD, flash memory, and the like, which is a non-volatile memory of which contents may be rewritten, or a combination of one or more thereof, for example.

The storage unit 72 stores food ingredients information 73, a food ingredients delivery schedule 74, and recipe information 75.

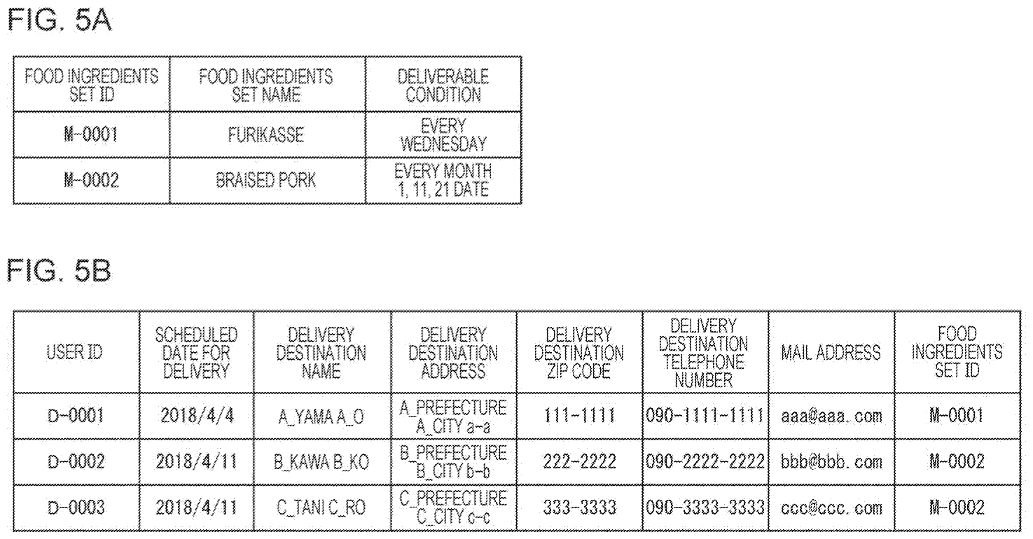

FIG. 5A shows an example of the food ingredients information table in which the food ingredients information 73 was written. As shown in FIG. 5A, the food ingredients information 73 includes information such as a food ingredients set ID, a food ingredients set name, and a deliverable condition of the food ingredients. The food ingredients set ID is information for identifying each of the food ingredients sets in which a plurality of food ingredients are combined into one set. The food ingredients set name and the deliverable condition of the food ingredients are associated with the food ingredients set ID unique to each of the food ingredients set.

FIG. 5B shows an example of a food ingredients delivery schedule table in which the food ingredients delivery schedule 74 is written. As shown in FIG. 5B, the food ingredients delivery schedule 74 includes information such as a delivery ID, a scheduled date for delivery, a delivery destination name, a delivery destination address, a delivery destination zip code, a delivery destination telephone number, mail address, a food ingredients set ID, and the like. The food ingredients delivery schedule 74 stores information on a delivery schedule of the food ingredients determined by an execution of the food ingredients delivery schedule determination unit 82 described below by the control unit 80.

The delivery ID is information for identifying each delivery, and is an ID unique to each delivery. The various information on the schedule of food ingredients delivery are stored in association with the delivery ID.

In addition, information on the delivery destination and the scheduled date for delivery of a food ingredients may be managed as a part of the order information shown in FIG. 3B.

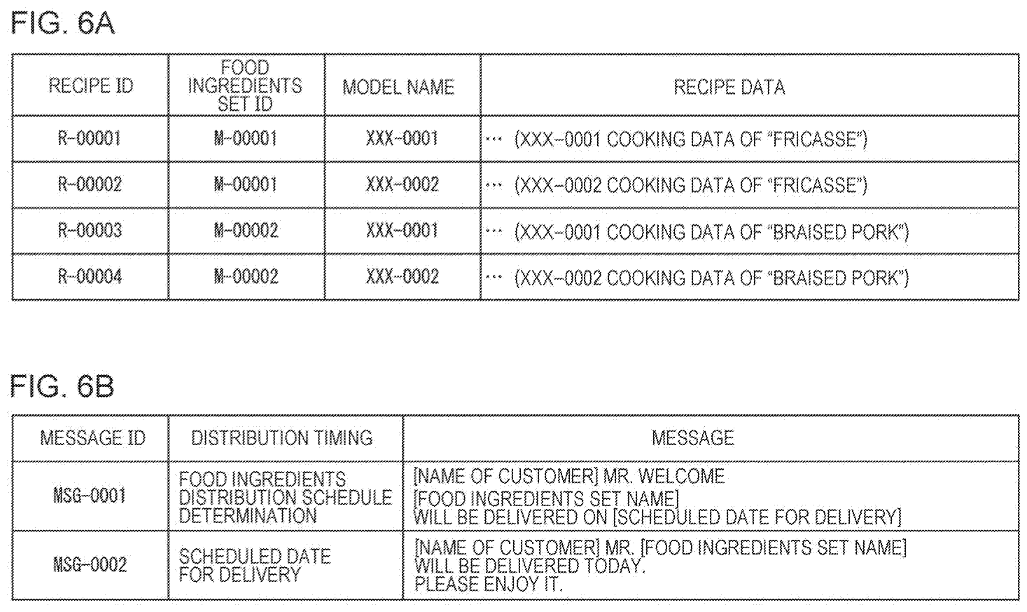

FIG. 6A shows an example of recipe information table in which the recipe information 75 is written. As shown in FIG. 6A, the recipe information 75 includes a recipe ID, a food ingredients set ID, a model name, and a recipe data. The recipe ID is information for identifying each recipe, and is an ID unique to each recipe. The recipe data is a program for performing automatic cooking in the cooking appliance 10, which is downloaded to the cooking appliance 10 to be used, and includes control information for controlling the cooking method, an output, a cooking time, and the like in the cooking appliance 10.

For example, even when the recipe is associated with the same food ingredients set ID “M-00001”, the recipe data differs according on a model of the cooking appliance 10 for cooking the food ingredients set. Therefore, the recipe information 75 includes, for one food ingredients set, a plurality of recipe information identified by recipe ID different for each model.

The control unit 80 is an arithmetic device provided with a function to control each unit of the food ingredients management server 70 in an integrated manner. The control unit 80 controls each unit of the food ingredients management server 70 by executing a program stored in one or more memories (for example, a RAM or a ROM) by one or more processors (for example, a CPU or the like), for example.

### Composition of Control Unit 80

The control unit 80 includes a food ingredients delivery instruction reception unit 81, a food ingredients delivery schedule determination unit 82, a message distribution unit 83, and a recipe distribution unit 84.

The food ingredients delivery instruction reception unit 81 receives a food ingredients delivery instruction transmitted from the user management server 30 through the communication unit 71.

The food ingredients delivery schedule determination unit 82 determines the delivery schedule of the food ingredients based on the food ingredients delivery instruction received by the food ingredients delivery instruction reception unit 81. The food ingredients delivery schedule determination unit 82 refers to the food ingredients information 73 based on the food ingredients set ID included in the food ingredients delivery instruction, and determines the scheduled date for delivery according to the deliverable conditions of the food ingredients included in the food ingredients information 73. The food ingredients delivery schedule determination unit 82 stores, in the storage unit 72, the determined scheduled date for delivery, together with information on the user (name, address, zip code, telephone number, and mail address) of the delivery destination included in the food ingredients delivery instruction and the food ingredients set ID, in association with the delivery ID.

The message distribution unit 83 transmits a message to the cooking appliance 10 associated with the user who is a target of delivering the food ingredients. The message distribution unit 83 transmits a message to the cooking appliance 10 according to a delivery schedule of the food ingredients determined by the food ingredients delivery schedule determination unit 82.

FIG. 6B shows an example of a message table in which a distribution timing of the message transmitted to the cooking appliance 10 by the message distribution unit 83 and message contents are written. As shown in FIG. 6B, in the message table, a plurality of messages are written in association with unique message IDs, respectively.

For example, when the food ingredients delivery schedule is determined by the food ingredients delivery schedule determination unit 82, the message distribution unit 83 generates and transmits a message of “Mr. A Yama a O, welcome. The food ingredients set “Fricasse” will be delivered on April 4th.”, which is distributed at a timing when the delivery schedule of the food ingredients is determined. As described above, the message distribution unit 83 generates a message including information of personalized content such as the name of the user, the name of the food ingredients set to be delivered, and the scheduled date for delivery, and transmits the message to the target cooking appliance 10.

In addition, the message distribution unit 83 generates a message such as “Mr. A Yama a O, and the food ingredients set “Fricasse” will be delivered today. Please enjoy it”, for example, on the scheduled date for delivery based on the delivery schedule determined by the food ingredients delivery schedule determination unit 82, and transmits the message to the target cooking appliance 10.

### Flow of Processing of Information Processing System 110

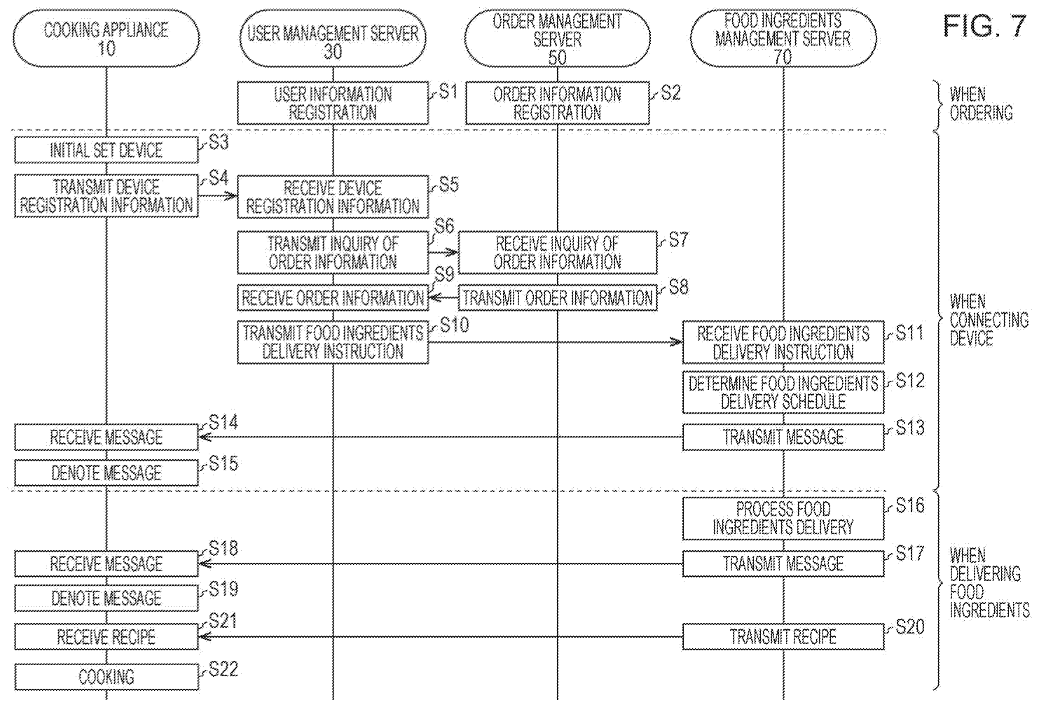

Hereinafter, the flow of processing in the information processing system 110 will be described with reference to FIG. 7. FIG. 7 is a sequence diagram showing the flow of processing in the information processing system 110. Prior to a processing in the information processing system 110, a food ingredients and a cooking appliance are ordered at the same time, and user information and order information are input from a webpage. The user information and the order information may be input by a person in charge of input, such as a salesperson who sells at the same time the food ingredients and the cooking appliance in a set, for example, at a home appliance retail store, for example. In addition, the user may input the user information and the order information from a website such as an EC site and order at the same time the food ingredients and the cooking appliance.

(Step S1) The control unit 40 of the user management server 30 stores user information received through the communication unit 31 in the storage unit 32 by an execution of the user information registration unit 41, and performs a user information registration.

(Step S2) The control unit 60 of the order management server 50 stores order information received through the communication unit 51 in the storage unit 52 by an execution of the order information registration unit 61, and performs the order information registration.

(Step S3) After the ordered cooking appliance 10 is delivered and handed to the user, the cooking appliance 10 is initialized by the user. The user connects the cooking appliance 10 to the Internet at the initial configuration of the cooking appliance 10. Further, in the initial configuration, the user inputs the user ID registered at the time of ordering to the cooking appliance 10.

(Step S4) The control unit 20 of the cooking appliance 10, triggered by the completion of the initial configuration, transmits device registration information to the user management server 30. The device registration information includes a user ID and a device ID.

The user ID may be directly input to the cooking appliance 10 by the user in step S3.

Further, the user may register in advance the user ID in a dedicated application installed in the terminal apparatus 5 such as a smartphone. Then, when the cooking appliance 10 is connected to the terminal apparatus 5 through, for example, Bluetooth (registered trademark) or the like in the initial configuration, the dedicated application installed in the terminal apparatus 5 may automatically transmit the device ID of the cooking appliance 10 to the user management server 30 in association with the user ID.

In addition, the cooking appliance 10 may be shipped in a state in which the user ID is registered in the cooking appliance 10 in advance. Then, when the cooking appliance 10 is handed at the user and the initial configuration is started to be connected to the Internet, the cooking appliance 10 may immediately transmit the device registration information in which the device ID and the user ID are associated with each other to the user management server 30.

(Step S5) The control unit 40 of the user management server 30 receives the device registration information by an execution of the device registration information reception unit 42. Although not shown, when receiving the device registration information, the control unit 40 of the user management server 30 may transmit a message such as “Welcome” to the cooking appliance 10. Moreover, when receiving the device registration information, the control unit 40 of the user management server 30 may transmit a plurality of distributable recipes to the cooking appliance 10.

(Step S6) The control unit 40 of the user management server 30 transmits an inquiry of order information to the order management server 50 by an execution of the order information acquisition unit 43. The order information acquisition unit 43 inquires about the order information based on at least one of the user ID and the device ID.

(Step S7) The control unit 60 of the order management server 50 receives the inquiry for the order information through the communication unit 51.

(Step S8) The control unit 60 of the order management server 50 transmits order information according to the inquiry by an execution of the order information transmission unit 62 to the user management server 30. The order information includes at least a food ingredients set ID.

(Step S9) The control unit 40 of the user management server 30 receives the order information by an execution of the order information acquisition unit 43.

(Step S10) The control unit 40 of the user management server 30 generates a food ingredients delivery instruction by an execution of the food ingredients delivery instruction transmission unit 44 based on the order information received by an execution of the order information acquisition unit 43, and transmits the generated food ingredients delivery instruction to the food ingredients management server 70. The food ingredients delivery instruction includes user information and the food ingredients set ID.

(Step S11) The control unit 80 of the food ingredients management server 70 receives the food ingredients delivery instruction by an execution of the food ingredients delivery instruction reception unit 81.

(Step S12) The control unit 80 of the food ingredients management server 70 determines the food ingredients delivery schedule by an execution of the food ingredients delivery schedule determination unit 82.

(Step S13) The control unit 80 of the food ingredients management server 70 generates a message relating to the food ingredients delivery schedule determined by an execution of the food ingredients delivery schedule determination unit 82 by an execution of the message distribution unit 83, and transmits the generated message to the cooking appliance 10. The message relating to the food ingredients delivery schedule includes at least information on scheduled date for delivery of the food ingredients.

(Step S14) The control unit 20 of the cooking appliance 10 receives a message by an execution of the message acquisition unit 22. The control unit 20 of the cooking appliance 10 may acquire a message by polling. In addition, the message may be distributed using WebSocket technology or the like.

(Step S15) The control unit 20 of the cooking appliance 10 denotes, on the display unit 12, the message received by an execution of the message acquisition unit 22 and presents the message to the user. In addition, the message from the food ingredients management server 70 may be transmitted to the terminal apparatus 5 together with the cooking appliance 10, and the user may be able to confirm the message from the dedicated application installed in the terminal apparatus 5.

(Step S16) The control unit 80 of the food ingredients management server 70 arranges the delivery of the food ingredients according to the food ingredients delivery schedule determined by an execution of the food ingredients delivery schedule determination unit 82.

(Step S17) The control unit 80 of the food ingredients management server 70 generates a message about the delivery status of the food ingredients by an execution of the message distribution unit 83, and transmits the generated message to the cooking appliance 10. For example, the message about the delivery status of the food ingredients may include information indicating that the delivery of the food ingredients is started.

(Step S18) The control unit 20 of the cooking appliance 10 receives a message by an execution of the message acquisition unit 22.

(Step S19) The control unit 20 of the cooking appliance 10 denotes, on the display unit 12, the message received by an execution of the message acquisition unit 22 and presents the message to the user.

(Step S20) The control unit 80 of the food ingredients management server 70 transmits a recipe according to the target cooking appliance 10, which is a recipe of the food ingredients of which the delivery is arranged by an execution of the recipe distribution unit 84.

(Step S21) The control unit 20 of the cooking appliance 10 receives a recipe by an execution of the recipe acquisition unit 23. The control unit 20 of the cooking appliance 10 may acquire a recipe by polling. Further, the recipe may be distributed using WebSocket technology or the like.

(Step S22) After the food ingredients has handed at hand, the user operates the cooking appliance 10 to cause the cooking appliance 10 to perform cooking of the food ingredients. The control unit 20 of the cooking appliance 10 controls the cooking unit 14 by an execution of the cooking control unit 24 based on the recipe acquired by an execution of the recipe acquisition unit 23 and cooks the food ingredients in the cooking unit 14.

Thus, in the information processing system 110, the food ingredients ordered at the same time together with the cooking appliance 10 is delivered to the user after the cooking appliance 10 is handed at the user and the initial configuration is completed. Thus, it is possible to avoid the risk that the food ingredients is handed the user before the installation of the cooking appliance 10 is finished, and the user may not properly cook the food ingredients. Therefore, even when the cooking appliance 10 and the food ingredients are ordered at the same time, the food ingredients may be delivered for proper cooking of the food ingredients.

In addition, since the food ingredients may be delivered for proper cooking of the food ingredients, it is easy to recommend the user to purchase the cooking appliance 10 and the food ingredients at the same time, and it is easy also for the user to purchase the cooking appliance 10 and the food ingredients at the same time.

### Embodiment 2

Other embodiments of the present disclosure will be described below. It should be noted that, for convenience of explanation, parts having the same function as the parts described in above Embodiment 1 are denoted by the same reference numerals, and description thereof will not be repeated.

In the information processing system 110 according to Embodiment 2, the user management server 30 only has a function of managing the registration information of the user and the registration information of the cooking appliance 10. Then when the user management server 30 receives the device registration information of the cooking appliance 10, the user management server 30 only transmits, to the order management server 50, a device registration completion notification indicating that the registration of the cooking appliance 10 is completed, and information on a delivery of the food ingredients is transmitted and received between the order management server 50 and the food ingredients management server 70. That is, the flow of the processing differs between the information processing system 110 according to Embodiment 2 and the information processing system 110 according to Embodiment 1.

It should be noted that, in Embodiment 2, the order management server 50 and the food ingredients management server 70 may be realized by the same server.

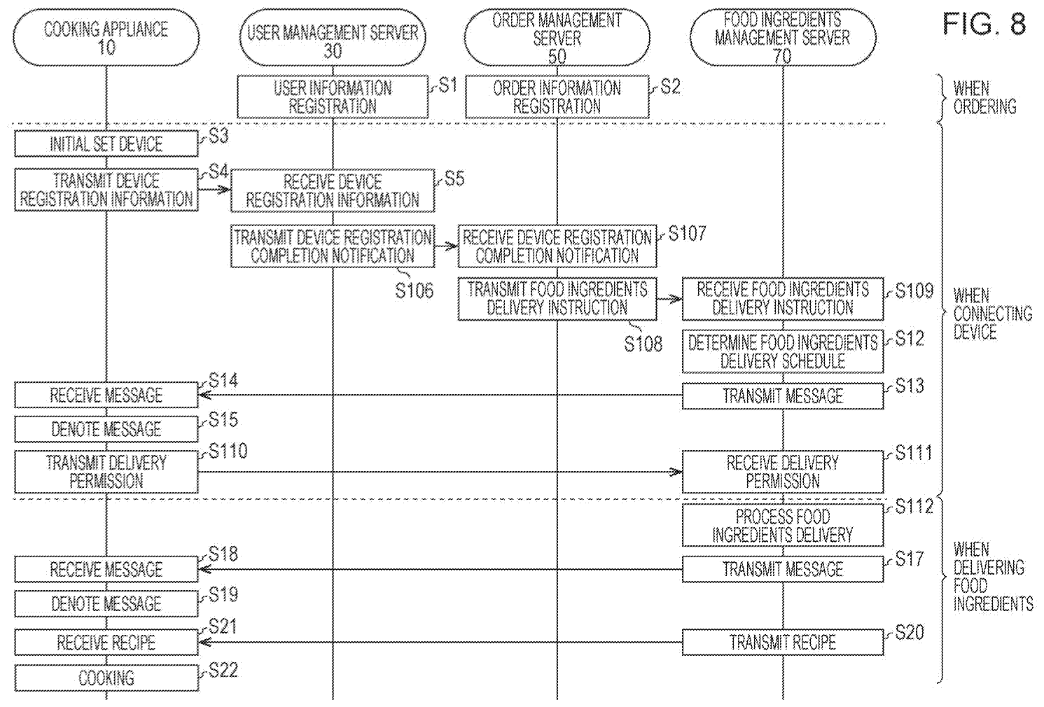

FIG. 8 is a sequence diagram showing the flow of processing in the information processing system 110 according to Embodiment 2.

Likewise as described in Embodiment 1, the processing of steps S1 to S5 described above is performed among the cooking appliance 10, the user management server 30, and the order management server 50. Then, when receiving the device registration information from the cooking appliance 10 (step S5), the user management server 30 proceeds to the process of step S106.

(Step S106) The control unit 40 of the user management server 30 transmits, to the order management server 50, the device registration completion notification indicating that the registration of the cooking appliance 10 is completed through the communication unit 31. The device registration completion notification transmitted from the user management server 30 includes a device ID and user information such as a user ID, a name, an address, a zip code, a telephone number, and mail address of the user.

(Step S107) The control unit 60 of the order management server 50 receives the device registration completion notification through the communication unit 51.

(Step S108) The control unit 60 of the order management server 50 refers to the received device registration completion notification and the order information stored in the storage unit 52, and generates a food ingredients delivery instruction. The control unit 60 of the order management server 50 transmits the generated food ingredients delivery instruction to the food ingredients management server 70. The food ingredients delivery instruction includes the user information and the food ingredients set ID.

(Step S109) The control unit 80 of the food ingredients management server 70 receives the food ingredients delivery instruction through the communication unit 71.

After the food ingredients management server 70 receives the food ingredients delivery instruction, in the information processing system 110, the processing of the steps S12 to S15 described above is performed between the cooking appliance 10 and the food ingredients management server 70. The control unit 20 of the cooking appliance 10 denotes a message about the food ingredients delivery schedule on the display unit 12 and receives whether or not the food ingredients delivery schedule is acceptable by operation by the user. In addition, the operation by the user whether or not to accept a food ingredients delivery schedule may also be performed from the terminal apparatus 5.

For example, the user may select whether or not to accept the food ingredients delivery schedule (scheduled date for delivery) presented to at least one of the cooking appliance 10 and the terminal apparatus 5, and may also select the desired delivery date from among other delivery date candidates.

(Step S110) The control unit 20 of the cooking appliance 10 transmits, through the communication unit 11, a delivery permission including information on whether or not to accept the presented delivery date or information on a desired delivery date in accordance with the operation by the user.

(Step S111) The control unit 80 of the food ingredients management server 70 receives the delivery permission through the communication unit 71.

(Step S112) The control unit 80 of the food ingredients management server 70 executes a processing of the food ingredients delivery in accordance with the received delivery permission.

After the processing of the food ingredients delivery is performed by the control unit 80 of the food ingredients management server 70, in the information processing system 110, the processing of the steps S17 to S22 described above is performed between the cooking appliance 10 and the food ingredients management server 70.

### Embodiment 3

In the embodiments described above, although an example in which one user management server 30, one order management server 50, and one food ingredients management server 70 are separately used is described, the functions included in each of the user management server 30, the order management server 50, and the food ingredients management server 70 may be realized on an individual server. Then, when a plurality of servers are applied, each server may be managed by the same provider and may be managed by different providers from each other.

### Embodiment 4

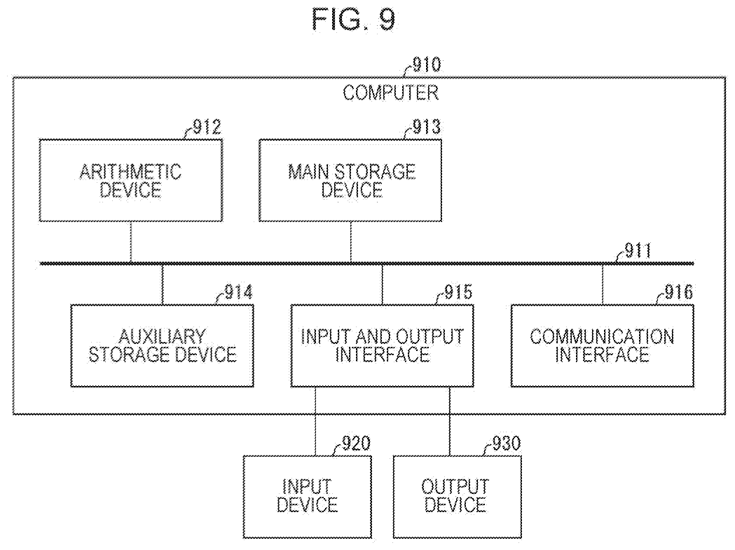

Each block of the user management server 30, the order management server 50, and the food ingredients management server 70 may be realized by a logic circuit (hardware) formed in an integrated circuit (IC chip) or the like, or may be realized by software. In the latter case, each of the user management server 30, the order management server 50, and the food ingredients management server 70 may be configured by using a computer (electronic computer) as shown in FIG. 9.

FIG. 9 is a block diagram illustrating a composition of a computer 910 usable as the user management server 30, the order management server 50, and the food ingredients management server 70. The computer 910 includes an arithmetic device 912 connected to each other through a bus 911, a main storage device 913, an auxiliary storage device 914, an input and output interface 915, and a communication interface 916. Each of the arithmetic device 912, the main storage device 913, and the auxiliary storage device 914 may be one or more processors (for example, CPU: Central Processing Unit), one or more random access memory (RAM), and one or more hard disk drives, for example. An input device 920 for the user to input various information to the computer 910 and an output device 930 for the computer 910 to output various information to the user are connected to the input and output interface 915. The input device 920 and the output device 930 may be built in the computer 910 or may be connected (externally connected) to the computer 910. For example, the input device 920 may be a keyboard, a mouse, a touch sensor, and the like, and the output device 930 may be a display, a printer, a speaker, and the like. In addition, it may be applied of a device having both the functions of the input device 920 and the output device 930, such as a touch panel in which a touch sensor and a display are integrated. Thus, the communication interface 916 is an interface for the computer 910 to communicate with an external device.

The auxiliary storage device 914 stores various programs for causing the computer 910 to execute as the user management server 30, the order management server 50, and the food ingredients management server 70. The arithmetic device 912 develops the program stored in the auxiliary storage device 914 onto the main storage device 913 and executes instructions included in the program to cause the computer 910 to execute each of the units included in the user management server 30, the order management server 50, and the food ingredients management server 70. The recording medium for recording information such as the program stored in the auxiliary storage device 914 may be a computer readable “non-transitory medium”, and may be a tape, a disk, a card, a semiconductor memory, a programmable logic, and the like, for example. In addition, the main storage device 913 may not be adopted as long as the computer can execute a program recorded on the recording medium without developing the program on the main storage device 913. It should be noted that each of the above devices (the arithmetic device 912, the main storage device 913, the auxiliary storage device 914, the input and output interface 915, the communication interface 916, the input device 920, and the output device 930) may be configured by one or a plurality of devices.

In addition, the program may be acquired from the outside of the computer 910, and in this case, it may be acquired through any transmission medium (a communication network, a broadcast wave, and the like). The present disclosure may also be realized in the form of a data signal embedded in a carrier wave in which the program is embodied by electronic transmission.

### CONCLUSION

An information processing device 100 according to a first aspect of the present disclosure is the information processing device 100 including communication units 31 and 51 and control units 40 and 60, in which, the control units 40 and 60, after acquiring order information on an order from a user through the communication unit 31 and 51, transmits a food ingredients delivery instruction corresponding to the order information due to acquiring of trigger information including at least one of user identification information, device identification information, and order identification information.

According to the above composition, in order to transmit the food ingredients delivery instruction due to acquiring of the trigger information, the trigger information is transmitted after the installation of the cooking appliance is completed, so that the food ingredients delivery instruction may be transmitted reliably after the installation of the cooking appliance is completed. Therefore, rather than the food ingredients being delivered before the installation of the cooking appliance is completed, the food ingredients may be delivered for proper cooking of the food ingredients.

According to a second aspect of the present disclosure, in the information processing device 100 according to the first aspect described above, the trigger information may include the user identification information and the device identification information.

According to the above composition, it is possible to identify the user and the device and transmit the food ingredients delivery instruction according to the user and the device. Thus, the food ingredients may be delivered for proper cooking of the food ingredients.

According to a third aspect of the present disclosure, in the information processing device 100 according to the first or second aspect described above, the device identification information may be information for identifying the cooking appliance 10 for cooking a food ingredients corresponding to the order information.

According to the above composition, the cooking appliance 10 for cooking the food ingredients corresponding to the order information may be identified, and the food ingredients may be delivered according to the cooking appliance 10, so that the food ingredients may be delivered for proper cooking of the food ingredients.

According to a fourth aspect of the present disclosure, in the information processing device 100 according to the first to third aspects described above, the trigger information may be information indicating that a preparation of the cooking appliance 10 associated with the order information is completed.

According to the above composition, the food ingredients delivery instruction may be transmitted after the preparation of the cooking appliance 10 is completed, so that the food ingredients may be delivered for proper cooking of the food ingredients.

A terminal apparatuses 10 and 5 according to a fifth aspect of the present disclosure is a terminal apparatuses 10 and 5 which communicate with the information processing device 100, in which, after acquiring the order information, the information processing device 100 transmits the food ingredients delivery instruction corresponding to the order information due to acquiring of the trigger information including at least one of the user identification information, the device identification information, and the order identification information, and the terminal apparatuses 10 and 5 are configured to transmit the trigger information to the information processing device 100.

According to the above composition, since the food ingredients delivery instruction corresponding to the order information is transmitted due to acquiring of the trigger information, the trigger information is transmitted at the timing at which the food ingredients may be appropriately cooked, so that the food ingredients may be delivered for proper cooking of the food ingredients.

The user management server 30, the order management server 50, and the food ingredients management server 70 according to each aspect of the present disclosure may be realized by a computer, in which case, a control program of the server realizing the user management server 30, the order management server 50, and the food ingredients management server 70 on the computer by causing the computer to execute each of the units (software elements) included in the user management server 30, the order management server 50, and the food ingredients management server 70, and a computer readable recording medium which records the control program are also included in the scope of the present disclosure.

The present disclosure is not limited to the embodiments described above, and various modifications may be realized within the scope of the claims, and embodiments obtained by appropriately combining the technical means disclosed in the different embodiments are also included in the technical scope of the present disclosure. Furthermore, new technical features may be formed by combining the technical means disclosed in each embodiment.

The present disclosure contains subject matter related to that disclosed in Japanese Priority Patent Application JP 2018-136199 filed in the Japan Patent Office on Jul. 19, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising a communication unit and a control unit,
wherein, after acquiring order information on an order from a user through the communication unit, the control unit transmits a food ingredients delivery instruction corresponding to the order information due to acquiring of trigger information including at least one of user identification information, device identification information, and order identification information.

2. The information processing device according to claim 1,
wherein the trigger information includes the user identification information and the device identification information.

3. The information processing device according to claim 1,
wherein the device identification information is information for identifying a cooking apparatus for cooking a food ingredients corresponding to the order information.

4. The information processing device according to claim 1,
wherein the trigger information is information indicating that a preparation of the cooking apparatus associated with the order information is completed.

5. A terminal apparatus which communicates with an information processing device,
wherein, after acquiring order information, the information processing device transmits a food ingredients delivery instruction corresponding to the order information due to acquiring of trigger information including at least one of user identification information, device identification information, and order identification information, and the terminal apparatus transmits the trigger information to the information processing device.

6. The terminal apparatus according to claim 5, further comprising:
a cooking unit which cooks a food ingredients.

7. An information processing system, comprising:
an order information transmission unit which transmits order information;
a trigger information transmission unit which transmits trigger information including at least one of user identification information, device identification information, and order identification information; and
a control unit which, after acquiring the order information, causes a food ingredients delivery instruction transmission unit to transmit a food ingredients delivery instruction corresponding to the order information due to acquiring of the trigger information.

8. A non-transitory computer readable recording medium which records a program for causing a computer to execute as the information processing device according to claim 1,
wherein the computer readable recording medium records a program for causing the computer to execute as the control unit.

9. A control method of an information processing device including a communication unit and a control unit, the control method comprising:
acquiring order information on an order from a user through the communication unit;
acquiring trigger information including at least one of user identification information, device identification information, and order identification information; and
transmitting a food ingredients delivery instruction corresponding to the order information due to acquiring of the trigger information.
